(19) United States
(12) Patent Application Publication
(10) Pub. No.: US 2008/0271095 A1
(43) Pub. Date: Oct. 30, 2008

(54) METHOD AND SYSTEM FOR PREVIEWING MEDIA OVER A NETWORK

(75) Inventor: Peter Shafton, San Francisco, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/739,532

(22) Filed: Apr. 24, 2007

(51) Int. Cl. H04N 7/173

(52) U.S. Cl. 725/87

(57) ABSTRACT

Systems and methods are disclosed that allow a user to preview media content on a device while the device is downloading the media content and without interrupting the downloading of the media content. In addition, the user may preview any location within a media file regardless of whether the media data for the location has been received by the user's device. The user's device, upon receipt of a command to preview a specific location within a file already being downloaded, determines if the data for that location have already been received. If so, the user's device generates a preview frame from the downloaded data. If not, the user's device transmits a preview request to the media server which generates the preview frame and transmits back to the user's device.

### COPYRIGHT NOTICE

A portion of the disclosure of this patent document contains material which is subject to copyright protection. The copyright or owner has no objection to the facsimile reproduction by anyone of the patent document or the patent disclosure, as it appears in the Patent and Trademark Office patent file or records, but otherwise reserves all copyright rights whatsoever.

### BACKGROUND

The Internet and other networks are now commonly used to deliver media objects (video files, streaming media data, music/audio files, image files, etc.) to end-user consumers. Typically, a consumer accesses such media by sending a request (typically via a browser program on the consumer's client computer) to a media server. In response, the media server retrieves the media data and transmits it to the consumer's device, where it is rendered (such as by a media player application) to the consumer.

However, media objects typically consist of significant amounts of data relative to the speed of most data transfer networks, such as the Internet, and the speed at which most devices can receive and/or store data via network connections. Furthermore, users or service operators may pay a premium for faster connections.

These aspects of the network delivery of media objects make the management of media retrieval, downloading and storage important, if nothing else to prevent consumer frustration with the speed of delivery of media to the consumer's device and the overall consumer experience of interacting with the media server.

### SUMMARY

Against this backdrop systems and methods have been developed that allow a user to preview media content on a device while the device is downloading the media content and without interrupting the downloading of the media content. In addition, the user may preview any location within a media file regardless of whether the media data for the location has been received by the user's device. The user's device, upon receipt of a command to preview a specific location within a file already being downloaded, determines if the data for that location has already been received. If so, the user's device generates a preview from the downloaded data. If not, the user's device transmits a preview request to the media server which generates the preview and transmits the preview back to the user's device.

The preview may be a single image or frame of data. Alternatively the preview may be a short video clip. The client receives this short preview video, decodes the video and displays the requested seek image instead of, or over the top of, the rendering video. The original download is never interrupted and therefore continues to download video while the user is previewing other portions of the file. Since the preview 120 is small (˜150 milliseconds of video) and ends quickly it has very little impact on the rate at which data is received via the original download. The overall solution is lightweight and allows users to continuously scrub outside the downloaded video range of the original stream. Scrubbing, that is selecting a different location within a media file than that currently being rendered, within the downloaded video range is still served by the locally cached video and does not require the secondary server request.

The present disclosure includes a description of a method of previewing media content. The method includes downloading a renderable media file. While downloading the renderable media file, the downloaded portion of the media file may be rendered to the user. The method further includes while downloading the renderable media file, receiving a preview command indicating a preview location different from the location within the renderable media file concurrently being rendered. In response to the preview command, the user's device displays a preview frame corresponding to the preview location without interrupting the downloading operation, in which the preview frame is generated from the renderable media file.

The present disclosure also includes a description of a computer-readable medium having computer-executable instructions for performing a method for previewing media content. The method includes downloading a renderable media file and, while downloading the renderable media file, receiving a preview command indicating a preview location different from the location within the renderable media file concurrently being rendered. In response, a preview frame corresponding to the preview location is displayed without interrupting the downloading operation, the preview frame generated from the renderable media file.

The present disclosure also includes a description of a method of previewing media content. The method includes transmitting a renderable media file to a remote device and receiving, from the remote device while transmitting the renderable media file, a preview request indicating a preview location identifying media data that has not yet been transmitted to the remote device. The method generates a preview frame corresponding to the preview location without interrupting the transmitting operation and transmits the preview frame to the remote device.

The present disclosure also includes a description of a system for previewing video files. The system includes a media server that receives a request for a video file and transmits the requested video file to the requester and that receives a preview request from the requestor and, in response, transmits a requested portion of the video file concurrently with transmitting the video file. The system may also include a requesting device that receives the requested video file and that generates a preview request to the server.

These and various other features as well as advantages will be apparent from a reading of the following detailed description and a review of the associated drawings. Additional features are set forth in the description which follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the invention in any manner, which scope shall be based on the claims appended hereto.

FIG. 1 illustrates an embodiment of an architecture for previewing media content.

FIG. 2 illustrates an embodiment of a method for previewing media content on a device while the device is downloading the media content and without interrupting the downloading of the media content.

FIG. 3 illustrates an embodiment of a server method for receiving preview requests from a client device while downloading media content to the same device.

FIG. 4 illustrates an embodiment of a GUI that may be used with systems and methods described herein.

FIG. 5 illustrates an alternative embodiment of a GUI for previewing media content.

### DETAILED DESCRIPTION

The systems and methods described herein allow a user to preview media content on a device while the device is downloading the media content and without interrupting the downloading of the media content. Although applicable to any type of media content like audio content (e.g., music), video content (e.g., television programs, movies, etc.) and slide shows, when an example is helpful the disclosure primarily discusses video embodiments in which media content in the form of a video file is being downloaded and previewed. The reader will understand that, however, the systems and methods herein can be equally applied to any type of media content which can be rendered over time.

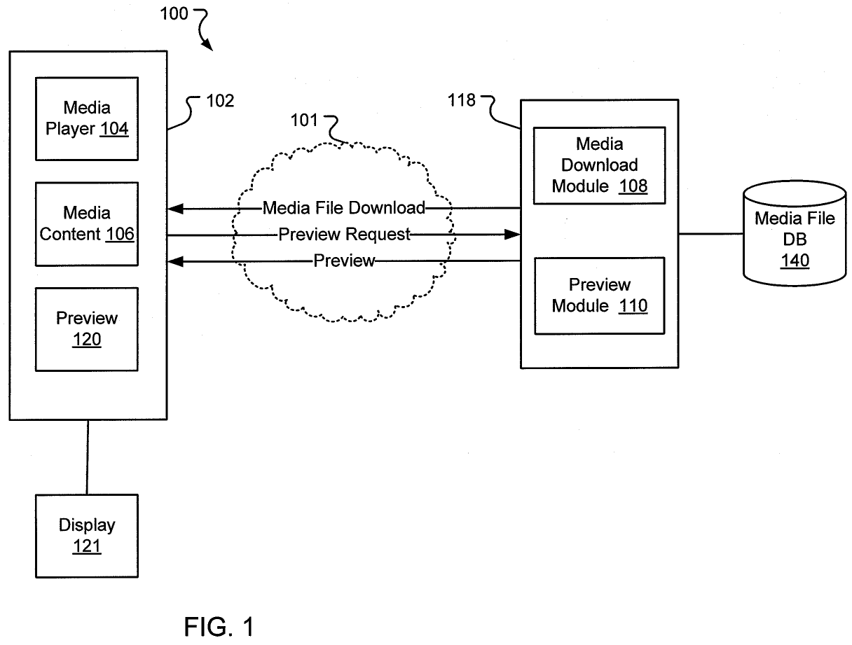

FIG. 1 illustrates an embodiment of an architecture for previewing media. The architecture 100 is a computing architecture in which media is being downloaded by a rendering device 102 for storage. The architecture 100 illustrated is a networked client/server architecture in which a rendering device (referred to as a “client”) issues media requests to a remote computing device (referred to as a “server”), which responds by transmitting the requested media content to the client for rendering to a user. The systems and methods described herein are suitable for use with other architectures as will be discussed in greater detail below.

The client 102 is alternatively referred to as a rendering device as, in addition to being able to receive and store media content from remote computers, it further is capable of rendering content to its user. Rendering devices may be able to load and play different formats of video, including MPEG, DivX, Xvid, AMV and SigmaTel Motion Video (SMV); audio, including MP3, WAV, and Ogg Vorbis; digital images, including BMP, JPEG, and GIF; and interactive media, such as flash animations.

To support this rendering capability, the client 102 may be a single purpose device consisting completely, or primarily, of hardware elements and, possibly, firmware or unchangeable sets of software instructions. Alternatively and as shown in FIG. 1, a rendering device may also be a computing device capable of obtaining and executing different software as needed. For the purposes of this disclosure, a computing device such as the client 102 or server 118 includes a processor and memory for storing and executing data and software. Computing devices may be provided with operating systems that allow the execution of software applications in order to manipulate data. In the embodiment shown, the client 102 is a computing device, such as a personal computer (PC), web-enabled personal data assistant (PDA) a smart phone, a portable media player device such as an IPOD, or a smart TV set top box.

In the embodiment shown, the client 102 is connected to the Internet 101 via a wired data connection or wireless connection such as a wi-fi network, a WiMAX (802.16) network, a satellite network or cellular telephone network. In an alternative embodiment, the client 102 may be connected to the source of the media content being downloaded via a private network or a direct connection.

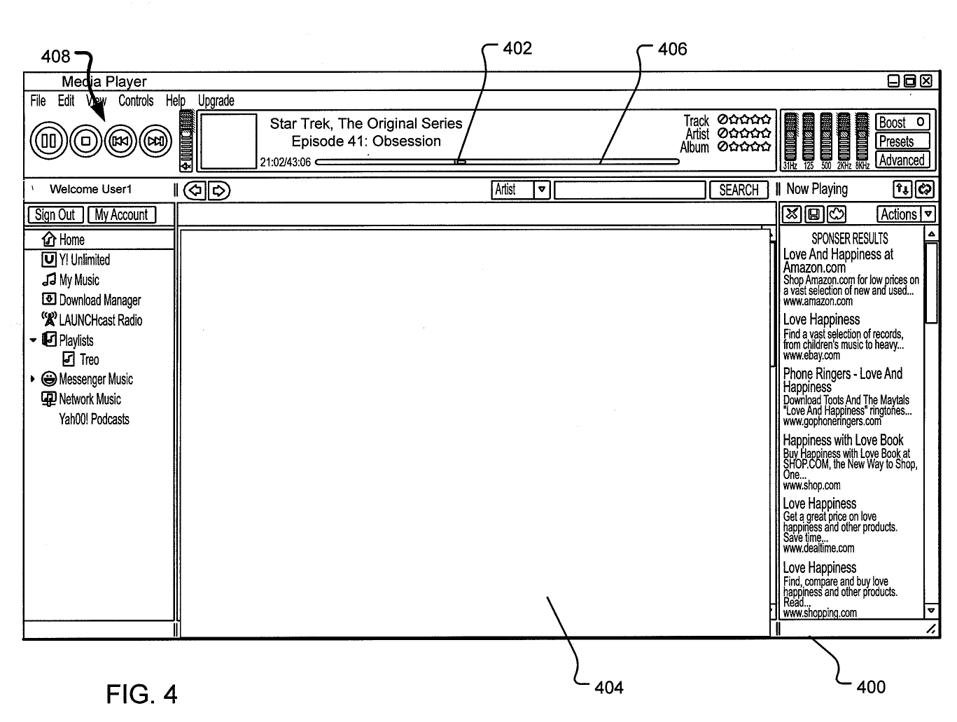

In the embodiment shown, the client 102 includes an application 104 for rendering media content. Such applications are commonly referred to as media player applications. Examples of such applications include WINDOWS MEDIA PLAYER and YAHOO! MUSIC JUKEBOX. The media player application 104, when executed, generates a graphical user interface (GUI) on a display 121 attached to or part of the computing device 102. An example of a GUI is illustrated and discussed in FIG. 4. The GUI includes a set of user-selectable controls through which the user of the client device 102 can interact to control the rendering of the media content. For example, the GUI may include a button control for each of the play-pause-rewind-fast forward commands commonly associated with the rendering of media on rendering devices. By selection of these controls, the user may cause the client 102 to obtain and render media content from local storage or from a remote source (e.g., a remote database, storage device or server) and control the rendering of the media to the user.

The architecture 100 also includes server 118, which may be a single server or a group of servers acting together. A number of program modules and data files may be stored in a mass storage device and RAM of the server 118, including an operating system suitable for controlling the operation of a networked server computer, such as the WINDOWS XP or WINDOWS 2003 operating systems from MICROSOFT CORPORATION.

In the architecture 100 shown, the client 102 is connected to the server 118 via a network, such as the Internet 101 as shown. In an embodiment, the client 102 is adapted to issue requests to the server computer 118 for media content. The requested media content may be stored as a discrete media object (e.g., a media file containing renderable media data that conforms to some known data format) that is accessible to the server 118. In the embodiment shown, the media file database 140 is provided that stores various media objects that can be requested by the client 102. In an alternative embodiment, the requested media content may be generated by the server 118 in response to the request.

Local data structures, including discrete media objects such as media files, may be stored on a mass storage device, such as the media file database 140. One or more mass storage devices may be connected to or part of any of the devices described herein including the client 102 or a server 118. The mass storage device includes some form of computer-readable media and provides non-volatile storage of data for later use by one or more computing devices. Although the description of computer-readable media contained herein refers to a mass storage device, such as a hard disk or CD-ROM drive, it should be appreciated by those skilled in the art that computer-readable media may be any available media that can be accessed by a computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

Client requests for media content may be generated by the media player 104 or may be generated by some other application, such as a browser. In an alternative embodiment, the content may be transmitted to the client 102 automatically, without the client generating a specific request for the content. In either case, many skilled in the art may refer to this operation as downloading the content from the server 118 to the client 102.

Regardless of how the downloading operation is initiated, the server 118 retrieves or otherwise accesses the requested media content and begins transmitting (downloading) the content to the client 102. This may be performed by a media download module 108, as shown. Absent any instruction to the contrary, the media content may be downloaded from its beginning. However, if the initial request designated that the download should begin from some specified location within the media content, the media download module 108 may begin downloading from the specified location. Depending on the amount of data in the media content being downloaded and the speed of the network connection between the client 102 and server 118, a significant amount of time may be required before all the requested content has been downloaded to the client 102 and stored.

The client 102, upon receipt of the requested media content, may store the media content for later rendering. However, in the methods and systems described herein, the client 102 renders, or is given a command to render, the media content before all of the media data has been received. In response, and as described in greater detail below, the client 102 determines what media data within the media content should be rendered and whether that data has already been downloaded. If it has been downloaded, a preview of the location may be shown or the video file may be rendered from the preview location—in either case, without interrupting the downloading.

If the data has not been downloaded, a preview request may be transmitted to a preview module 110 on the server 118 identifying a preview location within the media content. In response, the preview module 110 may select a predetermined amount of media data based on the preview location and transmit it to the client 102 separately for immediate rendering. In one mode of operation, the predetermined amount of media data (referred to as the preview 120) transmitted by the preview module may be data sufficient to create an image (referred to as a preview frame) on a video display corresponding to a video frame (or an audio preview snippet of sufficient length to be usefully perceived) within the media data at the preview location. By transmitting only the limited data necessary for the preview 120, the downloading of the preview 120 does not significantly slow the ongoing downloading of the media content.

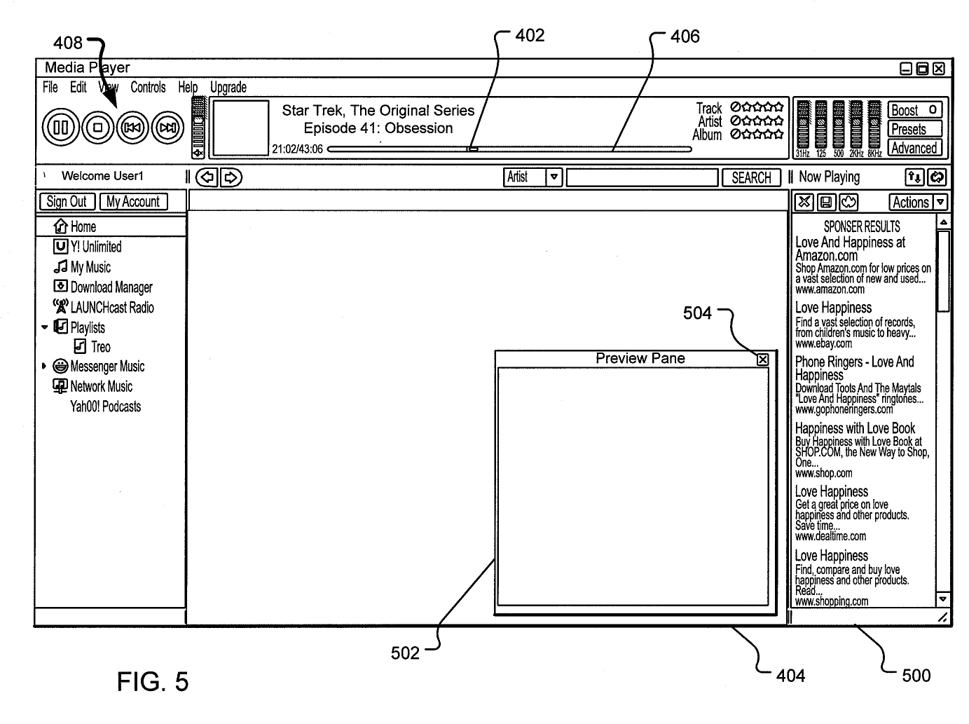

In an alternative embodiment, the preview 120 may include a greater amount of data such as enough data for one-half, one or two seconds of video playback. For example, in an embodiment, the preview 120 is only a small portion (˜150 milliseconds) of the video beginning at the requested preview location. The client application receives this short preview video, decodes the video and displays the requested seek image over the top of the original video, such as in another window as shown in FIG. 5. The original download is never interrupted and therefore continues to download video while the user is previewing other portions of the file. Since the preview 120 is small (˜150 milliseconds of video) and ends quickly it has very little impact on the rate at which data is received via the original download. The overall solution is lightweight and allows users to continuously scrub outside the downloaded video range of the original stream. Scrubbing within the downloaded video range is still served by the locally cached video and does not result in a preview request to the server 118.

The preview 120 may also be data provided at the same resolution or at a lower resolution than that of the downloading media content. The preview 120 may be stored locally or may simply be rendered and no permanent copy kept of the preview 120.

After rendering the preview 120 to the user, the user may be prompted to determine whether the user wishes to begin rendering from the preview location. In response to a user request to begin rendering from the preview location, a request for the media data beginning at the preview location may be generated and transmitted to the server 118. In an embodiment, this may interrupt the original downloading of the media content and begin a second download operation from the preview location.

In an alternative embodiment, a render from preview location request may not interrupt the original download. In which case the second download may be treated as a streaming download in which the media data streamed is received and immediately rendered by the client, rather than being stored for later rendering, thus creating only one copy of the downloaded file on the client 102.

FIG. 1 presents one embodiment a client/server architecture for rendering media content while the content is being downloaded. Many other embodiments are also possible, including different client/server embodiments in which various functions are performed by different components or distributed between several components.

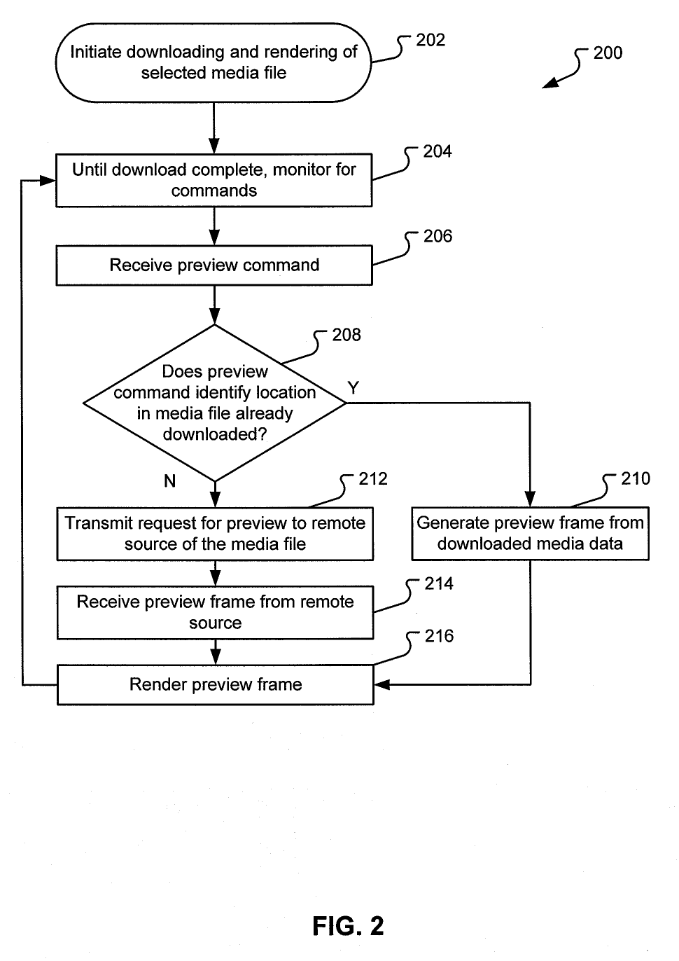

FIG. 2 illustrates an embodiment of a method for previewing media content on a device while the device is downloading the media content and without interrupting the downloading of the media content. In the method 200, a download of media content (in the embodiment shown a video file) is initiated in an initiate download operation 202. In response, the device begins and continues to receive the video file. The download may be initiated by a user request to download the video file, a user request to render the video file or an automatic process that started the download without user interaction. Initiate download operation 202 may be performed in response to a user request such as a click on a link of a web page associated with the video file, or a request generated by a media player in response to some other input. For example, in an embodiment, a request is generated when a user selects media content on a remote computing device, such as a media server that indicates that the user desires to render the asset on the user's client device, an action that requires the media content to be downloaded.

In this embodiment of the initiate download operation 202, the media server responds by beginning to transmit the media file to the client device, thereby initiating the downloading of the media file on the client device.

The client may, or may not, also render the video file while the downloading is occurring. For example, the client may begin rendering the video file once enough of the video file has been downloaded to the client device, possibly in response to a play command. If the transmission rate is greater than the consumption rate of the media player rendering the video file to the user, then the user may be unaware that the file has not been completely downloaded to his device.

After a download has been initiated by the initiate download operation 202, the source of the video file, e.g., the media server or media content repository, continues the download until all the media data has been transmitted and received by the client. During this period, a monitoring operation 204 is performed. Monitoring operation 204 includes monitoring for a preview command from the user of the client. The monitoring operation 204 may be performed by the same module that is performing the downloading or by a separate module.

In the embodiment shown, a preview command is received during the downloading as shown in receive preview command operation 206. In the receive preview command operation 206, a preview request has been received by the client device, such as in response to user input that indicates that the user wishes to preview a portion of the video file being downloaded. The preview request may be generated by the user interacting with the GUI of the client, such as by moving a user-selectable playback time marker on a timeline, selecting a portion of the timeline with a pointing device, selecting a preview mode, or by some other user action.

In response to the received preview command operation 206, a first determination operation 208 is performed to determine if the preview command indicates a preview location within the video file for which data has already been downloaded, or a preview location that has yet to be downloaded. For example, a user may be downloading and simultaneously rendering a large video file such as a movie or sporting event. While the movie is being downloaded the user may, through controls provided on the media player or otherwise on the client device, provide a preview command 206 indicating that the user wishes to preview a different portion of the video file than is currently being rendered.

In an embodiment, the received preview command operation 206 may be performed by the user moving a slider indicative of the location within the video file in which, as are known in the art, alternative methods of providing input command are also possible. For example, to distinguish between a preview command that will result in the display of a preview frame without interrupting the download and a render command that may result in the interruption of the downloading of the video file, a user may be provided with separate controls or some means of indicating the difference, such as holding down a key or a button while scrolling on the display bar.

The first determination operation 208 identifies the preview location selected by the preview command (such as by comparing the selected point within a timeline to the total length of the video file) and determines if the data for that location has been downloaded and currently resides on the client device. If the location indicated by the preview command does reside on the client device, i.e., it has already been downloaded as part of the downloading operation begun with initiation operation 202, then a render from local storage operation 210 is performed.

The render from local storage operation 210 includes identifying the location within the downloaded portion of the video file and rendering or otherwise displaying the appropriate media data. A render from local operation 210 does not interrupt the downloading initiated by the initiation operation 202.

The render from local storage operation 210 may cause the video file to be rendered from the identified location in the video file or may cause only a preview frame from the video file to be displayed to the user in response to the command received; the exact course of action taken depending on a predetermination made by either the user via a default selection or the developer of the client device/media player. In the latter case, the user may initiate rendering from the preview frame through the execution of a subsequent command to render from this preview point command (not shown).

However, if the identified media portion to be previewed has not been downloaded, a transmit request operation 212 is performed. The transmit preview request operation 212 generates and transmits a preview request to the remote source of the video file. The preview request indicates the preview location of the video file selected by the user to be previewed. In an embodiment, the preview request is a request transmitted separately from the downloading operation. That is, the request is independent of the communication data transfer session already taking place. The request may include an identification of the ongoing download session. The request may also be directed to a preview request address or location on the server different from that used to initiate the download. The preview address may be some predetermined variation of the original address used by the media server to identify the media content being downloaded or may be a preview address provided to the client by the server upon the initiation of the download. In yet another embodiment, the preview address may be the same as the video file's address, but the request may be a specific preview request that is interpreted by the server differently from a download request.

In response, the server or other source of the video file identifies the location within the video file from the preview request and generates one frame, i.e., an image frame or other image data, and returns that frame to the client device.

The preview frame generated as a result of render from local storage operation 210 or transmit preview frame request operation 212, discussed below, may not exactly match the preview location selected by the user. Rather, the nearest complete or convenient video frame may be selected. As mentioned above, a preview frame may or may not have the same resolution as the original video file and may or may not be in the same data format as the original. For example, a preview frame generated from a video file may be the closest I frame or key frame (i.e., complete frame of digital video) to the preview location. As another example, a preview frame generated from a video file may be an image, in an image format different from the video format, generated from the closest predicted frame, or P frame, to the preview location and the previous frames in order to obtain a more accurate preview frame. As another example, the preview may be in the form of a flash video (flv) file. The .flv may further be provided along with a flash client application if the client does not already have such an application or the capability of rendering a .flv file.

The client device receives the preview frame in a receive preview operation 214. After receiving the preview frame, the client device then displays the preview frame to the user in a render preview operation 216. As discussed previously, when displaying a preview frame in render preview operation 216, the render preview operation 216 does not interrupt the downloading of the video file from the video file source.

After the preview has been rendered (e.g., after displaying the preview frame or initiating rendering from the preview location depending on the embodiment), the method 200 returns to the monitoring operation 204. The method 200 then repeats from this point for any subsequent commands by the user until such time as the downloading is completed, at which point the rendering device resumes normal operation.

In an alternative embodiment, render preview frame operation 216 may include generating a second display window or otherwise displaying the preview over some or all of the rendering video in the GUI, as shown in FIG. 5. In this way, the preview frame may be displayed concurrently with the rendering of the video file so that not only is the download not interrupted or even significantly slowed, but the rendering of the video may not be interrupted either.

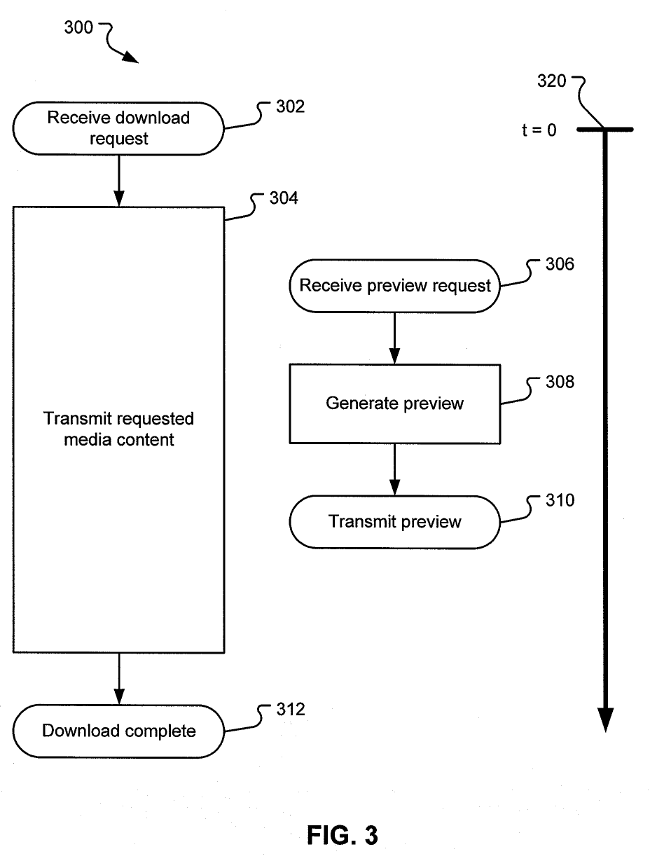

FIG. 3 illustrates an embodiment of a server method for receiving preview requests from a client device while downloading media content to the same device. In the method 300, a server is provided that can receive requests in a receive download request operation 302. The download request may be generated by the client or by some other computing system.

In response to the received download request operation 302, the server finds the video file that was requested and transmits the video file to the requester in a transmit video file operation 304. The file may or may not be retrieved from storage and saved in local server memory during this operation 304, depending on the architecture of the server. If the download request indicated a starting point of the transmission other than the beginning of the video file, then the transmit video file operation 304 locates that point within the data and begins transmitting data from that point.

The transmit video file operation 304 continues until the download is complete 312 some amount of time later (as shown by the time axis 320).

Independently, the server may also receive preview requests in a receive preview request operation 306. The receive preview request operation 306 may occur at any time and is independent of any download operation being performed. However, in the embodiment shown, the preview request is received during the downloading of the file in order to illustrate that the downloading is not interrupted. Alternatively, a system may be limited so that a preview request may be generated only by a client already downloading the video file. Such a system may direct the preview request to the actual device transmitting the video file so that the video file need not be retrieved from a file catalog a second time.

The receive preview request operation 306 is independent in that, even though it is received from the same source of a download request, it does not affect the transmission operation 304 if that operation is ongoing.

In response to the preview request, the request is processed in order to identify the preview location indicated by the preview request. From this information, the server then identifies the indicated location within the video file and generates the preview frame in a preview generation operation 308. The preview is generated as discussed above with reference to FIG. 2.

The preview frame is then transmitted in a transmit preview operation 310. As discussed above, after receiving a preview, the user has several options including issuing a subsequent preview request, issuing a render from the preview location request, or directing the client to resume rendering from the last point. In an embodiment, any subsequent request received from the client during the transmit video file operation 304 may be treated independently of any previous preview requests and the three operations 306, 308, 310 related to serving the preview request are repeated. Thus, the operations 306, 308, 310 related to a preview request may be performed multiple times while the video file is being downloaded, i.e. while the transmission operation 304 is being performed.

The reader should note that, as discussed above, a render request to render from a preview frame may, or may not, interrupt the original transmit video file operation 304. In either case, the render from preview location request is interpreted as a download request as described in receive download request operation 302 above, albeit with a designated starting point as that of the previous preview frame.

In addition, the determination of whether to interrupt downloading may be made by the client based on the available connection speed. If the connection speed is sufficiently large to simultaneously download two streams of media data and while simultaneously rendering one of the streams, the client may not interrupt the original download while rendering the stream from the preview location. However, if the client determines that sufficient bandwidth is not available to download and simultaneously render the streams, the client may automatically interrupt the original download in favor of the new download request or may prompt the user, e.g., with an “are you sure you want to stop downloading?” message prompt.

FIG. 4 illustrates an embodiment of a GUI 400 that may be used with systems and methods described herein. The GUI 400 includes a number of user-selectable controls through which the user of the client device can interact to control the rendering of the media content. For example, the GUI 400 may include a set of button controls 408 for each of the play-pause-rewind-fast forward commands commonly associated with the rendering of media on rendering devices, as shown. Other controls and control configurations are possible depending on the type of player and features supported by the rendering device. By selection of these controls, the user may cause the client to obtain and render media content from local storage or from the media server and control the rendering of the media to the user.

The embodiment of the GUI 400 shown is adapted for rendering video and includes an area 404 for displaying video content to a user such as moving video, images or video frames. Audio portions, if any, are rendered to some audio device such as headphones, a speaker or some other device.

The GUI 400 is further provided with a timeline 406 and a user-selectable playback time marker 402. Although not shown in FIG. 4, the timeline 406 may also display how much of the media content being rendered has been downloaded via another marker or via shading shown within the timeline 406.

In an embodiment, a user may command the media player to render from any location within the media content by either clicking on that point of the timeline or by dragging the playback time marker 402 to the desired preview location.

FIG. 5 illustrates an alternative embodiment of the GUI of FIG. 4. The GUI 500 includes all the same elements as described above with reference to FIG. 4. In addition, the GUI 500 includes a preview pane 502 that displays a preview 120 over the rest of the elements of the GUI 500 as previously described. The preview pane 502 may be an independent window or may be an area within the display area 404 of the GUI 500. The preview pane 502 may be provided with controls such as a close preview pane control 504 and a render from this point control (not shown).

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While various embodiments have been described for purposes of this disclosure, various changes and modifications may be made that are well within the scope of the present invention. For example, if a download is interrupted due to a user command to render from a preview frame, the data that has already been downloaded may be discarded and re-streamed later at the end of the transmit video file operation. Alternatively, the server, aware of the data that has already been provided, may modify the transmit video file operation so that the media data transmitted can be combined with the media data already provided by the original transmit video file operation.

Numerous other changes may be made that will readily suggest themselves to those skilled in the art and which are encompassed in the spirit of the invention disclosed and as defined in the appended claims.

1. A method of previewing media content, comprising:
downloading a renderable media file;
while downloading the renderable media file, rendering a retrieved portion of the media file;
while downloading the renderable media file, receiving a preview command indicating a preview location different from the location within the renderable media file concurrently being rendered;
ceasing rendering of the media file; and
displaying a preview frame corresponding to the preview location without interrupting the downloading operation, the preview frame generated from the renderable media file.

2. The method of claim 1 further comprising:
determining, based on the preview location, that media data of the renderable media file corresponding to the preview location have already been downloaded.

3. The method of claim 2 further comprising:
generating the preview frame from the media data corresponding to the preview location.

4. The method of claim 2 further comprising:
rendering the media file from the preview location.

5. The method of claim 1 further comprising:
determining, based on the preview location, that media data of the media file corresponding to the preview location have not already been downloaded.

6. The method of claim 5 further comprising:
transmitting a preview request identifying the preview location.

7. (canceled)

8. The method of claim 7 further comprising:
while concurrently displaying the preview frame and downloading the renderable media file, receiving a subsequent preview command indicating a subsequent preview location different from the preview location; and
displaying a subsequent preview frame generated from the renderable media file corresponding to the subsequent preview location without interrupting the downloading operation.

9. A method of previewing media content, comprising:
transmitting a renderable media file to a remote device;
receiving, from the remote device while transmitting the renderable media file, a preview request indicating a preview location identifying media data that has not yet been transmitted to the remote device;
generating a preview frame corresponding to the preview location without interrupting the transmitting operation; and
transmitting the preview frame to the remote device.

10. The method of claim 9 further comprising:
receiving, from the remote device while transmitting the renderable media file, a subsequent preview request indicating a subsequent preview location identifying media data that has not yet been transmitted to the remote device;
generating a subsequent preview frame corresponding to the preview location without interrupting the transmitting operation; and
transmitting the subsequent preview frame to the remote device.

11. The method of claim 9 further comprising:
receiving, from the remote device while transmitting the renderable media file, a transmit from preview location request;
ceasing transmitting the renderable media file to the remote device; and
transmitting, from the preview location within the renderable media file, the renderable media file to the remote device.

12. The method of claim 9 further comprising:
receiving a download request for the renderable media file from the remote device;
retrieving the renderable media file from storage; and
storing the renderable media file in memory.

13. The method of claim 12 further comprising:
generating the preview frame from the renderable media file in memory.

14. The method of claim 12 further comprising:
generating the preview frame from the renderable media file in storage.

15. A system for previewing video files, comprising:
a media server that receives a request for a video file and transmits the requested video file to the requestor and that receives a preview request from the requestor and, in response, transmits a requested portion of the video file concurrently with transmitting the video file.

16. The system of claim 15 further comprising:
a requesting device that receives the requested video file, and in response to a preview command indicating a portion of the requested video file, generates a preview request to the server.

17. The system of claim 15, wherein the preview request identifies a preview location within the video file that has not yet been transmitted to the requestor when the preview request is received, and wherein the media server further comprises:
a preview module that generates a preview frame based on the preview location from the video file; and
transmits the preview frame to the requestor.

18. (canceled)

19. The system of claim 17 wherein the preview frame is an I frame nearest the preview location.

20. The system of claim 17 wherein the preview frame contains data in a different format than data in the video file.

21. (canceled)

22. The system of claim 16 wherein the requesting device further determines from the preview command if the media data corresponding to a preview location identified in the command has already been received and, if the media data has already been received, generates a preview frame based on the media data.

23. A computer-readable medium having computer-executable instructions for performing a method comprising:
downloading a renderable media file;
while downloading the renderable media file, receiving a preview command indicating a preview location different from the location within the renderable media file concurrently being rendered; and
displaying a preview frame corresponding to the preview location without interrupting the downloading operation, the preview frame generated from the renderable media file.

24. The computer-readable medium of claim 23 wherein the method further comprises:
determining, based on the preview location, whether or not media data of the renderable media file corresponding to the preview location have already been downloaded.

25. The computer-readable medium of claim 24 wherein the method further comprises:
generating the preview frame from the media data corresponding to the preview location.

26. The computer-readable medium of claim 24 wherein the method further comprises:
rendering the media file from the preview location.

27. (canceled)

28. The computer-readable medium of claim 27 wherein the method further comprises:
transmitting a preview request identifying the preview location.

29. (canceled)

30. The computer-readable medium of claim 29 wherein the method further comprises:
while concurrently displaying the preview frame and downloading the renderable media file, receiving a subsequent preview command indicating a subsequent preview location different from the preview location; and
displaying a subsequent preview frame generated from the renderable media file corresponding to the subsequent preview location without interrupting the downloading operation.
